(19) United States
(12) Patent Application Publication
(10) Pub. No.: US 2026/0147174 A1
(43) Pub. Date: May 28, 2026

(54) FACTORY TERMINATED HOLLOW CORE FIBER CABLES FOR FAST AND RELIABLE FIELD DEPLOYMENT

(71) Applicant: Relativity Networks, Inc., Winter Park, FL (US)

(72) Inventors: Jason Eichenholz, Orlando, FL (US); Rodrigo Amezcua Correa, Orlando, FL (US); Jose Enrique Antonio-Lopez, Orlando, FL (US)

(21) Appl. No.: 19/397,047

(22) Filed: Nov. 21, 2025

Related U.S. Application Data
(60) Provisional application No. 63/725,413, filed on Nov. 26, 2024.

(51) Int. Cl. G02B 6/44; G02B 6/032

(52) U.S. Cl. CPC G02B 6/4429; G02B 6/032

(57) ABSTRACT

A fiber cable including a hollow core fiber (HCF) is disclosed. The HCF may be factory terminated at one or both ends of the HCF with a solid or glass core end fiber (EF). The factory termination of the HCF with the EF provides low loss, low reflection and high mechanical reliability coupling between the HCF and the solid/glass core EF. The EF enables simple, reliable and fast splicing between two factory terminated HCF cables, thereby enabling an operator on the field to conveniently connect two factory terminated HCF cables to form an elongated HCF cable. Further, the EF is compatible with conventional single-mode fibers, thereby enabling a fast and low loss splicing between a factory terminated HCF cable and a conventional single-mode (or multimode) fiber cable.

### CROSS-REFERENCE TO RELATED APPLICATION

The present application claims the benefit of U.S. Provisional Patent Application 63/725,413 filed on Nov. 26, 2025, which is incorporated herein by reference in its entirety.

### TECHNICAL FIELD

The present disclosure relates generally to hollow core fiber cables, and more specifically to hollow core fiber cables factory terminated on one or both ends with solid core/glass core end fibers (EFs).

### BACKGROUND OF THE INVENTION

Increasing cloud compute, machine learning and data storage requirements are driving the construction of hyper-scale datacenters at a fast rate. Novel factory terminated/connectorized conventional solid or glass core single mode fiber (SMF)/multimode fiber (MMF) cables are optimized to accelerate deployment time, and are utilized to reduce splicing time and complete the data center interconnect link-up at a faster pace. These solutions typically include factory terminated ends with optical connectors to avoid splicing of the cables. Since the SMF/MMF cables are factory terminated with optical connectors, an operator on the field is not required to splice the cables, and thus the pace of deployment/connection of the cables (e.g., at the data center) is considerably increased.

Furthermore, as the demand for telecom services, Internet, voice or video calls, information exchange, etc. has exponentially increased over the past few decades, newer telecom infrastructure is being developed that offers higher speed, enhanced bandwidth and lower latency. An example of such a telecom infrastructure includes hollow-core fibers (HCF). An HCF offers various benefits over a traditional glass or solid core optical fiber (SMF/MMF) including, but not limited to, a high average and peak power capability, high damage thresholds, low latency, low non-linearities, etc.

Consequently, HCFs, including various types such as antiresonant fibers, antiresonant slab fibers, photonic bandgap fibers, Kagome fibers, nested antiresonant nodeless hollow core fibers (NANFS), double nested antiresonant nodeless hollow core fibers (DNANFS), and other low-loss HCFs, have emerged as promising solutions for low latency and high capacity data transmission in data center interconnect networks. However, their more complex design and geometry compared to conventional solid core/glass core fibers (conventional glass core SMF, MMF) pose challenges in practical implementations and field installation. For example, one challenge lies in the precise cleaving, alignment and complex splicing process required for splicing HCF to HCF and HCF to conventional glass core fibers (conventional solid core SMF, MMF), which complicates the deployment of HCF cables. Splicing HCF cables require specialized equipment, specialized personnel, and increases the installation time relative to the cables with conventional SMF/MMF. Specifically, HCF cables or HCFs are more fragile (or more brittle) than conventional glass core fibers, and hence are more prone to snapping or breaking during installation, e.g., when the operator performing the splicing is not skilled enough to handle HCF splicing.

Therefore, a need exists to facilitate field installation of HCF cables.

### SUMMARY

A fiber cable is disclosed in accordance with one or more illustrative embodiments. In some embodiments, the fiber cable may include one or more hollow core fibers (HCF) that may be factory terminated with a solid or glass core end fiber (EF) at one end or both the ends of the HCF(s). For example, in certain embodiments, a proximal end of the HCF may be factory terminated with a first solid or glass core EF. In other embodiments, the proximal end of the HCF may be factory terminated with the first solid or glass core EF, and a distal end of the HCF may be factory terminated with a second solid or glass core EF.

The solid or glass core EF may be a single-mode fiber or a multimode fiber.

In some embodiments, the solid or glass core EF may be of a first predefined length, and the HCF may be of a second predefined length. The second predefined length may be greater than the first predefined length. In an exemplary embodiment, the first predefined length may be greater than five meters. Further, a cladding diameter or a mode field diameter of the HCF may be equivalent to a cladding diameter or a mode field diameter of the solid or glass core EF.

The HCF may be factory terminated at the proximal (and/or distal) end with the solid or glass core EF by coupling the proximal end of the HCF with a distal end of the solid or glass core EF. In certain embodiments, the proximal end of the HCF may be coupled with the distal end of the solid or glass core EF by fusion splicing. In other embodiments, the proximal end of the HCF may be coupled with the distal end of the solid or glass core EF by using a mechanical splice or couplers.

In some embodiments, the proximal end of the HCF and the distal end of the solid or glass core EF are protected by at least one of a buffer tube, an aramide yarn or a tape, after the proximal end of the HCF is coupled with the distal end of the solid or glass core EF. In further embodiments, the proximal end of the HCF and the solid or glass core EF are protected with one or more of a protective tube, a heat shrink material, an epoxy material or a mechanical seal, after the proximal end of the HCF is factory terminated with the solid or glass core EF.

In certain embodiments, the distal end of the solid or glass core EF (that is coupled with the proximal end of the HCF) is angle cleaved. In additional embodiments, the distal end of the solid or glass core EF is surface treated or coated with an antireflection coating.

In some embodiments, a distal end of the solid or glass core EF is spliced or coupled with the proximal end of the HCF, and a proximal end of the solid or glass core EF is further spliced with a second solid or glass core EF of a second factory terminated HCF of a second fiber cable to form an elongated fiber cable.

In other embodiments, a distal end of the solid or glass core EF is spliced or coupled with the proximal end of the HCF, and a proximal end of the solid or glass core EF is further spliced with another solid or glass core fiber.

In yet another embodiment, a distal end of the solid or glass core EF is spliced or coupled with the proximal end of the HCF, and a proximal end of the solid or glass core EF is terminated with a connector. The connector may be, for example, a Lucent connector (LC), a Square connector (SC), an LC angled physical connector (LC-APC), an SC angled physical connector (SC-APC), and/or the like.

In some embodiments, a coupling of the proximal end of the HCF and the solid or glass core end fiber (EF) has an associated loss of less than 1 dB. In some aspects, the associated loss is less than 0.1 dB.

Further, a coupling of the proximal end of the HCF and the solid or glass core end fiber (EF) has an associated reflectance loss of less than −20 dB. In some aspects, the associated reflectance loss is less than −65 dB.

In certain embodiments, a coupling of the proximal end of the HCF and the solid or glass core EF is re-coated or protected with a splice protector.

In some embodiments, the fiber cable further includes a pulling grip that encloses the proximal end that is factory terminated with the solid or glass core EF. The pulling grip is configured to protect the proximal end that is factory terminated from ambient environment and facilitate deployment of the fiber cable inside conduits or enable/facilitate passing of the fiber cable through walls. In certain embodiments, the pulling grip is water resistant and is configured to handle a pulling tension of more than 500 Newton. In some embodiments, a diameter of the pulling grip is greater than a diameter of the fiber cable. In some aspects, a difference between the diameter of the pulling grip and the diameter of the fiber cable is less than 2 centimeter. Further, in an exemplary embodiment, a length of the pulling grip is less than 2 meters.

In some embodiments, the fiber cable may include one or more solid or glass core fibers, in addition to the HCF(s) described above. The solid or glass core fibers included in the fiber cable may be single-mode fibers or multimode fibers. In certain embodiments, during manufacturing, on one or both ends of the cable, the fibers that are part of the cable are placed in a splice closure or splice tray to further facilitate installation, allowing for quicker joining to another cable during the installation process.

In certain embodiments, the fiber cable may be packaged on a reel.

In accordance with further embodiments of the present disclosure, an HCF is disclosed that includes a proximal end and a distal end. The proximal end of the HCF may be factory terminated with a distal end of a solid or glass core EF.

In accordance with further embodiments of the present disclosure, a method to couple two fiber cables is disclosed. The method may include providing a first fiber cable comprising a first hollow core fiber (HCF). The first HCF may be factory terminated at a proximal end of the first HCF with a first solid or glass core EF. The method may further include providing a second fiber cable comprising a second HCF. The second HCF may be factory terminated at a distal end of the second HCF with a second solid or glass core end fiber EF. The method may additionally include coupling or splicing the first solid or glass core EF with the second solid or glass core EF.

### BRIEF DESCRIPTION OF THE DRAWINGS

Various embodiments of the invention are disclosed in the following detailed description and the accompanying drawings.

FIG. 1A depicts a schematic diagram of a hollow core fiber (HCF) cable factory terminated with solid core/glass core end fibers (EFs) at one end in accordance with one or more embodiments of the present disclosure.

FIG. 1B depicts a schematic diagram of an HCF cable factory terminated with solid core/glass core EFs at both ends in accordance with one or more embodiments of the present disclosure.

FIG. 2A depicts an example first HCF cable including a plurality of factory terminated HCFs in accordance with one or more embodiments of the present disclosure.

FIG. 2B depicts an example second HCF cable including a plurality of factory terminated HCFs in accordance with one or more embodiments of the present disclosure.

FIG. 3 depicts an example factory terminated HCF cable with a pulling grip in accordance with one or more embodiments of the present disclosure.

FIG. 4A depicts a first example reel of a factory terminated HCF cable in accordance with one or more embodiments of the present disclosure.

FIG. 4B depicts a second example reel of a factory terminated HCF cable in accordance with one or more embodiments of the present disclosure.

FIG. 5 depicts a connection of two factory terminated HCF cables in accordance with one or more embodiments of the present disclosure.

FIG. 6 depicts a connection of multiple factory terminated HCF cables in accordance with one or more embodiments of the present disclosure.

FIG. 7 depicts a connection of a factory terminated HCF cable with a conventional solid/glass core fiber cable in accordance with one or more embodiments of the present disclosure.

FIG. 8 is a flow diagram of a method to connect two factory terminated HCF cables in accordance with one or more embodiments of the present disclosure.

### DETAILED DESCRIPTION

The invention can be implemented in numerous ways, including as a process; an apparatus; a system; a combination of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure are directed to a fiber cable (specifically an HCF cable) that includes one or more hollow core fibers (HCFs), and may also include one or more conventional solid core, glass cores fibers (SMF, MMF). The HCF cables can be utilized for outdoor, outdoor/indoor and indoor installations.

It is known that an HCF includes a hollow core and one or more anti-resonant elements. In the anti-resonant HCFs, light or optical signal is guided in the hollow core as a result of anti-resonant properties of thin walled structures extending along the length of the fiber. Since the light or optical signal is guided in a “hollow” core in an HCF, as opposed to a solid/glass core in the case of a standard solid/glass core fiber, the speed of travel of optical signal (and hence the speed of signal transmission) in an HCF is considerably greater than the speed of signal transmission in a solid/glass core optical. Specifically, since the optical signal travels through the hollow core in an HCF, which is essentially vacuum having an index of refraction (“n”) as 1, the optical signal travels through the HCF at a speed that is equivalent to (or substantially equivalent to) the speed of light (as speed of signal in the medium=speed of light (“c”)/n). This is in contrast to the speed of optical signal in a solid/glass core fiber, which typically has an index of refraction in a range of 1.4-1.5, and hence offers a lower speed of transmission of the optical signal.

Furthermore, HCFs offer various benefits over standard solid/glass core fibers including, but not limited to, high average and peak power capability, high damage thresholds, low latency, low non-linearities, etc. Considering these advantages and the greater speed of signal transmission, many telecom service providers are adopting HCFs for signal transmission, to provide enhanced services to their customers. For example, many service providers are deploying HCF cables (that include the HCFs) for datacenter interconnect networks. In this case, the HCF is used to connect two datacenters with low latency and high bandwidth. The term “datacenter”, as described in the present disclosure, may mean any type of processor or processing unit (e.g., a Central Processing Unit (CPU), Graphics Processing Unit (GPU), and/or the like).

Typically, when an HCF cable is deployed for datacenter interconnect network, the HCF cable is installed outside the data center building inside conduits, which enter the building into the data center optical cable entry facility. At this location, the HCF cable is typically spliced or coupled with indoor conventional solid/glass core fiber cables (or SMF cables). The splice of an HCF to a conventional SMF is time consuming and a challenging process that requires special equipment and personnel. If not done properly, the splice or the coupling point may become a point of failure and may result in considerable signal loss.

To make the HCF cable installation process easier for the personnel on the field or to make the installation process more similar to what the standard installation process is currently, the present disclosure proposes factory terminating one or both ends of the HCF cable with a predefined length of a solid/glass core end fiber (EF). Specifically, to make the installation process of the HCF cables easier on the field, the present disclosure proposes to make one or both the ends of the HCFs to be similar to the current, more traditional solid or glass core optical fibers. This may facilitate in leveraging the existing installation resources (e.g., equipment and/or personnel) associated with the solid/glass core fiber cables to install the HCF cables. Furthermore, such a structure of the HCF cable may make the installation process easier as the current/traditional solid or glass core optical fibers can bend relatively easily as compared to the HCFs. Therefore, by using the solid/glass core EFs, the personnel may easily bend the fiber/cable on the field during the installation process, without having to worry about snapping or breaking the HCFs. In certain embodiments, during cable manufacturing (that is prior to the installation of the cable in the field) one end of the fibers that are part of the cable are placed in a splice closure or splice tray to further facilitate installation, allowing for quicker joining to another cable during the installation process.

In some aspects, the factory termination of one or both the ends of the HCF cable is done by splicing/coupling the HCFs of the HCF cable to solid/glass core EFs. By doing so, the solid/glass core EFs can be spliced to conventional SMF cables inside the data center, thereby making the installation process simpler.

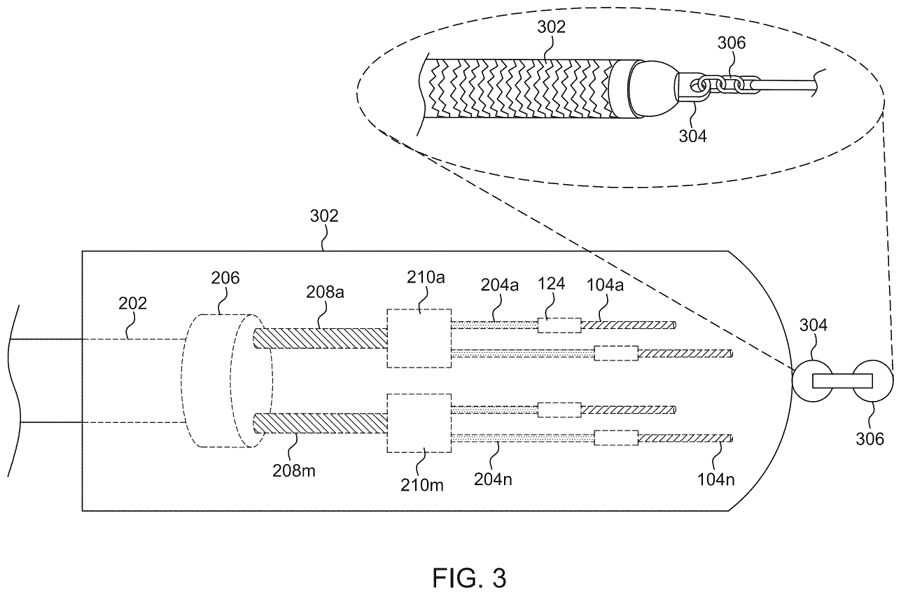

The factory termination is performed in a controlled factory environment, before the cable is installed at the data center. In certain embodiments, to facilitate the installation of the HCF cable inside the conduits, the factory terminated HCF cable may include a pulling grip/pulling sock (shown as pulling grip 302 in FIG. 3, and described later in the description below) that protects the factory terminated end/ends of the HCFs of the HCF cable and allows the pulling of the factory terminated HCF cable inside a conduit.

HCF cables with factory terminated solid/glass core EFs offer better performance (e.g., lower splice loss, lower reflection, etc.) and reduce the risk associated with field installation (e.g., reworks, high insertion loss or high reflection associated to poor splicing quality between HCF to conventional SMF cables or HCF cables to HCF cables).

In some aspects, the term “factory terminated”, as used in the present disclosure, may mean splicing or coupling an end of an HCF with an end of a solid/glass core EF of a predefined length. The HCF to EF coupling may be achieved by fusion splicing, or by the use of alternative methods including using a mechanical splice, couplers, etc. In an exemplary aspect, while coupling the HCF to the EF, the ends of the HCF and the EF to be coupled are stripped, cleaned and cleaved precisely. Thereafter, while performing fusion splicing, the ends of the two fibers are melted (by using heat) and then fused together. The fusion splicing is typically done via a fusion splicer. Once the fusion splicing is complete, the coupled joint is typically covered with a tube or a sleeve (e.g., a heat-shrink plastic sleeve), which protects and strengthens the joint. Mechanical coupling, on the other hand, is done via plastic or glass alignment sleeve.

Fusion splicing is preferred for splicing/coupling the HCF with the EF, as fusion splicing provides lower insertion loss, lower reflectance, and high performance (a stronger signal and better protection against failure). Further, fusion splicing facilitates in making a strong, reliable and weatherproof joint between the ends of the HCF and the EF that are coupled with each other.

In some aspects, the HCF to EF splice/coupling may be proof-tested to guarantee their mechanical reliability, before the HCF cable is installed on the field. In one exemplary embodiment, once on the field, the other end of the EF (that is not coupled with the HCF) may be spliced/coupled with conventional solid/glass core SMF to enable low splice loss between the factory terminated HCF cable and conventional SMF cables that may be present at the data center. In another exemplary embodiment, the other end of the EF (that is not coupled with the HCF) may be spliced/coupled with a second EF of a second factory terminated HCF cable, to enable an operator to make an elongated HCF cable. For example, a first EF of a first factory terminated HCF cable may be coupled with a second EF of a second factory terminated HCF cable to form an elongated HCF cable that may have a length equivalent to a sum of the individual lengths of the first and second factory terminated HCF cables.

In yet another exemplary embodiment, the other end of the EF (that is not coupled with the HCF) may be terminated with a connector, to allow connector coupling to conventional glass core/solid core fibers (thereby further simplifying the HCF cable installation process). The connector may be, for example, a Lucent connector (LC), a Square connector (SC), an LC angled physical connector (LC-APC), an SC angled physical connector (SC-APC), and/or the like.

In certain embodiments, the HCF to EF splicing/coupling, as disclosed in the present disclosure, has a loss of below 1 dB, preferably below 0.5 dB, preferably below 0.2 dB, and preferably below 0.1 dB. In further aspects, the HCF to EF splice/coupling, as disclosed in the present disclosure, offers a low reflectance, preferably below −20 dB, preferably less than 50 dB, and preferably less than −65 dB.

The factory terminated HCF cables, as described in the present disclosure, offer various advantages over conventional HCF cables. For example, the factory termination provides low loss, low reflection and high mechanical reliability coupling between the HCF and the solid/glass core EF. The EF enables simple, reliable and fast splicing between two factory terminated HCF cables, thereby enabling an operator on the field to conveniently connect two factory terminated HCF cables to form an elongated HCF cable. Further, the EF is compatible with conventional single-mode fibers, thereby enabling a fast and low loss splicing between a factory terminated HCF cable and a conventional single-mode (or multimode) fiber cable. Furthermore, as described above, the factory terminated end (or ends) of the HCF cable may include a pulling grip that protects the factory termination/s and facilitate easy deployment of the HCF cable inside conduits or passing through walls.

The factory terminated HCF cables, as described herein, may serve multiple purposes including, but not limited to, simplifying and speeding up HCF cable installation and splicing, simplifying and speeding up optical testing of HCFs at different stages of cable installation, protecting the hollow core of HCFs against water/moisture diffusion during cable handling, transportation and installation. The factory terminated HCF cables including the EF protected by a pulling grip, as described above, addresses key challenges in HCF optical cable deployment and splicing.

Further details of the factory terminated HCF cables are described below in conjunction with the drawings/figures.

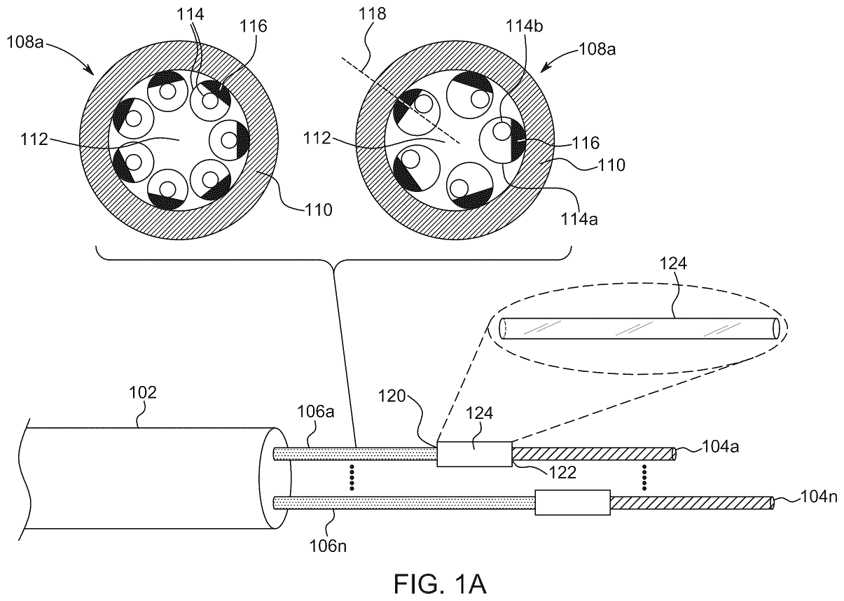

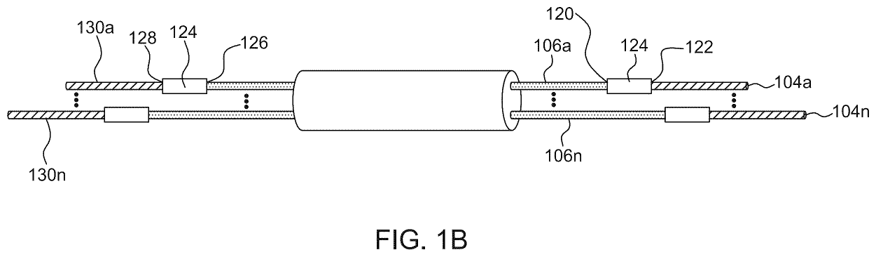

Turning now to the figures, FIG. 1A depicts a schematic diagram of a hollow core fiber (HCF) cable 102 factory terminated with one or more solid core/glass core end fibers (EFs) 104a . . . n (referred to as EF 104) in accordance with one or more embodiments of the present disclosure. The HCF cable 102 may include one or more HCFs 106a . . . n (referred to as HCF 106). In some aspects, the HCF cable 102 may additionally include one or more solid or glass core fibers (which may be single-mode fibers or multimode fibers). Such solid or glass core fibers that may be included in the HCF cable 102 are not depicted in FIG. 1A for the sake of simplicity.

The HCF 106, as described in the present disclosure, may include a hollow core and one or more anti-resonant elements. It is known that in anti-resonant HCFs, light is guided in the hollow core as a result of anti-resonant properties of thin walled structures extending along the length of the fiber. In some aspects, the HCF 106 may incorporate any hollow core fiber design such as, but not limited to, antiresonant fibers, antiresonant slab fibers, photonic bandgap fibers, Kagome fibers, nested antiresonant nodeless hollow core fibers (NANFS), or double nested antiresonant nodeless hollow core fibers (DNANFS). Two example cross-sectional structures of the HCF 106 are shown in FIG. 1A as HCFs 108a and 108b.

In some embodiments, the HCF 108a may include one or more cladding structures 110 providing a hollow interior region 112. In the example embodiment depicted in FIG. 1A, the HCF 108a includes a single cladding structure 110 formed as a circular tube. In some embodiments, the HCF 108a may further include multiple AR elements 114 distributed in the hollow interior region 112 provided by the cladding structure 110. As an illustration, the HCF 108a is depicted to include seven sets of nested AR elements 114, where each of the nested AR elements includes one AR element 114 within another AR element 114. In some embodiments, the HCF 108a further includes one or more support structures 116, which may position at least one AR element 114 within the HCF 108a. For example, at least one AR element 114 may be connected to at least one support structure 116. The support structures 116 may generally be formed as or be in contact with the cladding structure 110 and/or any of the AR elements 114.

In further embodiments, the HCF 108b may be substantially similar in structure to the HCF 108a, except that a single “offset” second AR element 114b may be located within the interior region of a first AR element 114a. Stated another way, the second AR elements 114b are not symmetrically placed within the first AR elements 114a and are thus not centered on a radial line 118 from the center of the HCF 108b.

The example cross-sectional structures of the HCFs 108a, 108b depicted in FIG. 1A should not be construed as limiting. The cross-sectional structures of the HCF 108a, 108b are depicted in FIG. 1A just for illustrative purpose, and the HCFs included in the HCF cable 102 may have different cross-sectional structures, without departing from the scope of the present disclosure. Further example HCF cross-sectional structures are depicted in the U.S. patent application Ser. No. 18/662,573, filed on May 13, 2024, which is incorporated by reference in its entirety in the present disclosure.

In accordance with the present disclosure, one or both ends of one or more HCFs 106 may be factory terminated with the EFs 104. FIG. 1A specifically depicts an embodiment where one end (e.g., a proximal end 120) of the HCF 106 is factory terminated or spliced/coupled with the EF 104. In particular, the proximal end 120 of the HCF 106 may be factory terminated or spliced/coupled with a distal end 122 of the EF 104. In some aspects, the EF 104 may include any fiber design such as, but not limited to, glass core fiber (GCF) sections, solid core fiber (SCF) sections, etc. Further, the EF 104 may be a single-mode fiber or a multimode fiber, and hence the factory terminated end(s) of the HCF(s) 106 or the HCF cable 102 may resemble a conventional standard SMF/MMF, thereby considerably simplifying and easing the installation process of the HCF cable 102 on the field (as the equipment on the field/data center currently is predominantly designed for standard SMF/MMF and the personnel are also majorly trained for installing SMF/MMF cables, as described above).

In some aspects, the HCF 106 is factory terminated at the proximal end 120 with the EF 104 by coupling/splicing the proximal end 120 of the HCF 106 with the distal end 122 of the EF 104 at a factory (in a controlled environment, and by personnel skilled in coupling/splicing an HCF with a solid/glass core EF). The coupling/splicing may be achieved by any suitable technique to achieve low loss (e.g., low insertion loss) and low back reflection. As described above, the proximal end 120 of the HCF 106 may be coupled with the distal end 122 of the EF 104 by fusion splicing or by using a mechanical splice or couplers. Fusion splicing is preferred for splicing/coupling the HCF 106 with the EF 104, as fusion splicing provides lower insertion loss, lower reflectance, and high performance (a stronger signal and better protection against failure). Further, fusion splicing facilitates in making a strong, reliable and weatherproof joint between the proximal end 120 of the HCF 106 and the distal end 122 of the EF 104 that are coupled with each other.

In some aspects, to make a strong and reliable splice/joint, the distal end 122 of the EF 104 (that is coupled with the proximal end 120 of the HCF 106) is angle cleaved before splicing to achieve low reflection to the HCF 106. Furthermore, the distal end 122 may additionally be surface treated or coated with an antireflection coating to make a low insertion loss and low reflectance joint with the HCF 106.

As described above, the coupling of the proximal end 120 of the HCF 106 and the distal end 122 of the EF 104 has an associated loss of less than 1 dB, preferably below 0.5 dB, preferably below 0.2 dB, and preferably below 0.1 dB. Further, the coupling of the proximal end 120 of the HCF 106 and the distal end 122 of the EF 104 has an associated reflectance loss of less than −20 dB, preferably less than −50 dB, and preferably less than −65 dB.

In some aspects, the proximal end 120 of the HCF 106 and the distal end 122 of the EF 104 (or the coupling joint of the HCF 106 and the EF 104, and/or some or entire length of the EF 104) may be protected by a buffer tube, an aramide yarn, a tape, a protective tube, a heat shrink material, an epoxy material, a mechanical seal, a splice protector and/or the like, after the proximal end 120 is coupled with the distal end 122. For example, as shown in FIG. 1A, the joint of the proximal end 120 of the HCF 106 and the distal end 122 of the EF 104 may be enclosed (and hence protected) by a heat-shrink plastic sleeve 124 after the proximal end 120 and the distal end 122 may be spliced/coupled, to secure the mechanical reliability of the factory termination. In further aspects, the proximal end 120 of the HCF 106 and the distal end 122 of the EF 104 (or the coupling joint of the HCF 106 and the EF 104) may be recoated, after the proximal end 120 is coupled with the distal end 122.

In certain embodiments, a length of the HCF 106 may be substantially greater than a length of the EF 104. For example, if the EF 104 is of a first predefined length and the HCF 106 is of a second predefined length, the second predefined length may be substantially greater than the first predefined length. In an exemplary aspect, the first predefined length may be greater than 30 cm, greater than 1 meter, or greater than 5 meters to facilitate routing in racks, splicing closures, splicing panels, patch panels, and/or the like, e.g. when the HCF 102 terminated with the EF 104 may be spliced/coupled to another EF (e.g., a second EF) of a second factory terminated HCF cable or spliced/coupled to SMF/MMF or a connector at a data center.

In some embodiments, a cladding diameter or a mode field diameter of the HCF 106 (at the proximal end 120) may be equivalent to a cladding diameter or a mode field diameter of the EF 104 (as the distal end 122), to achieve low splice loss and to simplify the splicing process. Furthermore, in certain embodiments, the HCF/EF splice position or coupling joint may be proof tested, after the HCF 106 is factory terminated with the EF 104 as described above, to secure/guarantee the mechanical reliability of the factory termination. Specifically, the optical properties of the factory terminated HCF cable 102 may be conveniently analyzed/measured by directly connecting the EF 104 to a test device (e.g., an optical time domain reflectometer (OTDR), an optical spectrum analyzer, loss measurements, chromatic dispersion measurements, polarization mode dispersion measurements, etc.).

The factory terminated HCF cable 102, as described above, provides various advantages over conventional HCF cables. For example, as the HCF-to-EF splice/coupling seals the hollow core of the HCF 106, the EF 104 protects the HCFs 106 in the HCF cable 102 from external environment during cable transportation, installation, etc. This facilitates in enhancing the reliability of HCF cables. Further, the factory terminated HCF cable 102 facilitates faster and simpler splicing/connection of the HCF cable 102 to other factory terminated HCF cables (as splicing/coupling two EFs of two factory terminated HCF cables is relatively simpler than splicing two conventional HCF cables). Furthermore, the factory terminated HCF cable 102 facilitates faster and simpler splicing/connection of the HCF cable 102 to a conventional SMF/MMF cable (as splicing/coupling the EF 104 of the factory terminated HCF cable 102 with an SMF/MMF cable is relatively simpler than splicing a conventional HCF cable with an SMF/MMF cable).

The factory terminated HCF cable 102 further facilitates faster and simpler splicing/connection of the HCF cable 102 to test and communications equipment. Additionally, as described above, since the current telecom infrastructure (e.g., data centers) is mostly based on SMF/MMF cables, the HCF cable 102 factory terminated with EFs 104 enables more cost-effective deployment of HCF optical cables (as different equipment and/or personnel specifically trained on HCF splicing are not required for HCF cable deployment).

In further embodiments, the EF 104 may be composed of two or more glass core fibers (GCFs), ensuring efficient coupling of optical signals. Further, the EF 104 utilized for factory terminating the HCF cable 102 may have low bending loss characteristics, which facilitates the splicing of the factory terminated HCF cable 102. In some embodiments, the EF 104 may be compatible with conventional single-mode fibers, which simplifies the splicing of the HCF cable 102 to conventional single-mode optical fibers/cables.

To summarize, the present disclosure discloses splicing of the HCFs 106 included in the HCF cable 102 with the EFs 104 at a factory (e.g., “factory splice/connector”), which enables high-quality, low-loss coupling and which is proof-tested to ensure a desired level of performance. Further, antireflection coatings and/or angle cleave may be added to the fiber ends (i.e., the proximal end 120 of the HCF 106 and the distal end 122 of the EF 104) to reduce back reflections.

FIG. 1B depicts a schematic diagram of the HCF cable 102 factory terminated with solid core/glass core EFs at both ends in accordance with one or more embodiments of the present disclosure. Specifically, FIG. 1A depicts the HCF cable 102 as a single-ended factory terminated HCF cable, and FIG. 1B depicts the HCF cable 102 as a double-ended factory terminated HCF cable.

In the exemplary embodiment depicted in FIG. 1B, distal ends 126 of one or more HCFs 106 may be factory terminated or spliced/coupled with proximal ends 128 of second solid/glass core EFs 130a . . . n (or EF 130). In this manner, both ends of the HCF 106 (i.e., the proximal end 120 and the distal end 126) may be factory terminated or spliced/coupled with EFs (e.g., the EF 104 and the EF 130, at respective ends).

The remaining elements depicts in FIG. 1B are similar to the elements that are depicted in FIG. 1A, and hence are not described again here for the sake of simplicity and conciseness.

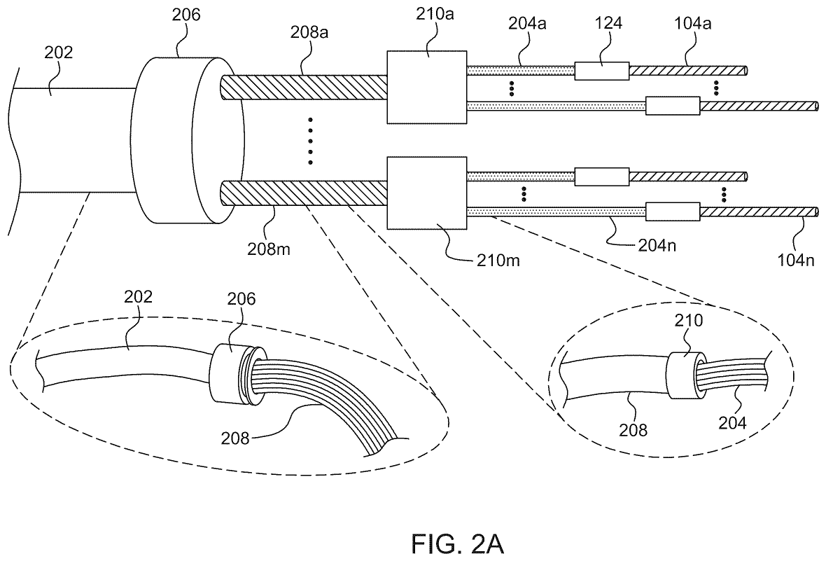

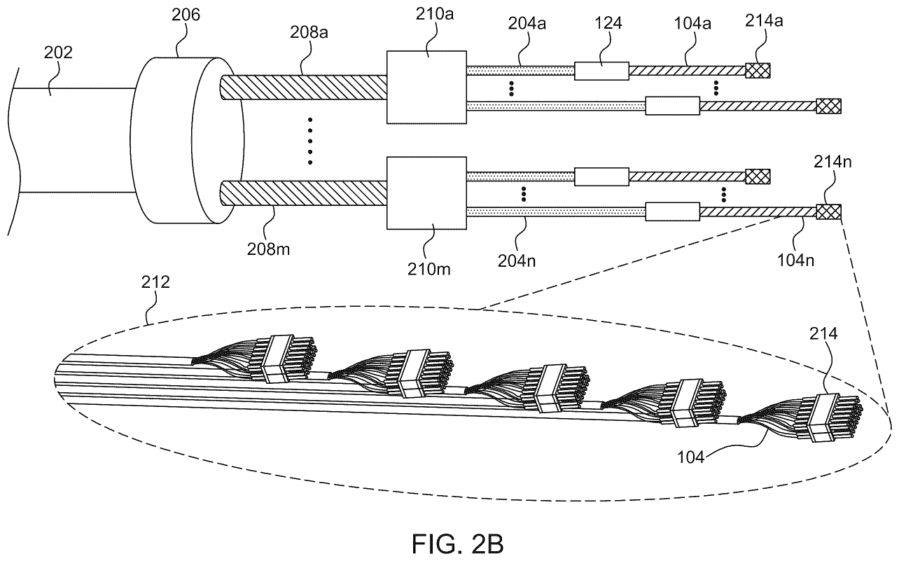

FIG. 2A depicts an example first HCF cable 202 including a plurality of factory terminated HCFs 204a . . . n (or HCFs 204) in accordance with one or more embodiments of the present disclosure. The HCFs 204 may be similar to the HCFs 106 described above. Further, the HCF cable 202 may be similar to the HCF cable 102 described above, however, the HCF cable 202 may additionally include a cable break out device 206 from which a plurality of loose tubes 208a . . . m (or tubes 208, which may be buffer tubes or subunits) may break out or fan out from the HCF cable 202. Further, the HCF cable 202 may include a plurality of fiber break out devices 210a . . . m (or fiber break out devices 210) from which the HCFs 204 may break out.

In the case of the HCF cable 202 (which includes the plurality of HCFs 204), at least one and preferably all the HCFs 204 are factory terminated with the EFs 104, in the similar manner as described above.

In the exemplary embodiment depicted in FIG. 2A, the cable break out device 206 is used to break-out/fan-out the tubes 208 from the HCF cable 202. The cable break out device 206 may include a tube, epoxy, heat shrinkable material for protection, etc. Further, the fiber break out device 210 is used to break-out/fan-out the HCFs 204 from each tube 208, which are then factory terminated with the EFs 104 as described above. The fiber break out device 210 may include a tube, epoxy, heat shrinkable material for protection, etc.

In some aspects, the count of HCFs 204 breaking out from each tube 208 may be the same. In other aspects, the counts of HCFs 204 breaking out from the tubes 208 may be different. Furthermore, the HCFs 204 may be individually protected with a buffer tube or other form of protection after being extracted out of the tube 208.

In an exemplary aspect, when the tubes 108 contain multiple HCFs (as shown in FIG. 2A), identification of each EF 104 may be achieved by color coding or by using other methods such as band marks, special marking, etc. In additional or alternative aspects, in such cases, each EF 104 may be of increasing length to facilitate in splicing and identification (as shown in an exemplary snapshot 212 depicted in FIG. 2B).

In further aspects, in such cases, the HCF and EF terminations may be organized individually, or organized in groups, such as inside buffer tubes, subunits, central tube, ribbon, etc. In addition, at the HCF cable/factory termination interface, one or multiple derivation tubes may be used to separate and organize the HCFs 204.

Furthermore, the end(s) of the HCF 204 (that may be broken out) may be sealed by using tube, epoxy, heat shrink materials, etc., to avoid water ingress inside the HCF cable 202. In addition, the HCF to EF splice/coupling may be protected by re-coating, heat shrink, and/or any other encapsulating/protection method. Further, each individual EF 104 may be protected by a buffer tube, tight buffer or other form of protection.

In further aspects, the HCF cable 202 may also include conventional GCF/SCF, which may be broken out individually or remain inside the tubes 208 or bundling elements. In this case, the tubes 208/subunits may contain a mix of HCFs 204 and conventional SCF/GCF.

Remaining details of the elements depicted in FIG. 2A are the same as the details of the elements described above in conjunction with FIGS. 1A and 1B, and hence are not described again here for the sake of simplicity and conciseness.

It should be noted that the HCF cable 202 may also be of a different construction (e.g., have no-loose tube 208) such as: central tube, subunit, ribbon, etc. Therefore, the construction of the HCF cable 202 depicted in FIG. 2A should not be construed as limiting.

FIG. 2B depicts the HCF cable 202 including the HCFs 204 and a plurality of connectors 214a . . . n (or connectors 214), in accordance with one or more embodiments of the present disclosure. In the exemplary embodiment depicted in FIG. 2B, a proximal end of each EF 104 (i.e., the end of the EF 104 that is not spliced/coupled with the HCF 204) is terminated with the connector 214. The connector 214 may be one of a Lucent connector, a Square connector, an LC angled physical connector (LC-APC), an SC angled physical connector (SC-APC), and/or the like. The connector 214 may enable easy and fast connection of the factory terminated HCF cable 202 to conventional SMF/MMF based equipment on the field/data center. Further, as shown in the snapshot 212, in this case, each EF 104 may be of increasing length to facilitate in splicing and identification. The remaining elements depicted in FIG. 2B are the same as the elements depicted in FIG. 2A, and hence are not described again here for the sake of simplicity and conciseness.

FIG. 3 depicts the HCF cable 202 with a pulling grip 302 in accordance with one or more embodiments of the present disclosure. In some aspects, the pulling grip 302 may enclose the proximal end 120 of the HCF 204 that is factory terminated with the EF 104 (and other cable components, as shown in FIG. 3), thereby protecting the factory terminated end from ambient environment and facilitate deployment of the HCF cable 202 inside conduits.

The diameter of the pulling grip 302 is preferably no more than 2 cm larger than the diameter of the HCF cable 202 for easier routing inside conduits. Stated another way, a difference between the diameter of the pulling grip 302 and the diameter of the HCF cable 202 is less than 2 centimeter (with the diameter of the pulling grip 302 being greater than the diameter of the HCF cable 202). Furthermore, a length of the pulling grip 302 may be shorter than 2 meters, or shorter than 1 meter to facilitate installation of the HCF cable 202 inside conduits. The pulling grip 302 may handle a force or pulling tension of over 200 Newton, or over 500 Newton. The pulling grip 302 may be water proof or water resistant for preventing humidity or water damage of the factory terminated HCF cable 202.

In certain embodiments, the pulling grip 302 may include a pulling eye 304 to provide connection between the factory terminated HCF cable 202 and a pulling rope. The pulling grip 302 may additionally include a swivel 306 to prevent twisting of the factory terminated HCF cable 202 and the pulling rope during installation.

In some aspects, after installation into the cable path, the pulling grip 302 may be removed by the operator, thus presenting the factory terminated EF 104 for splicing or connectorization.

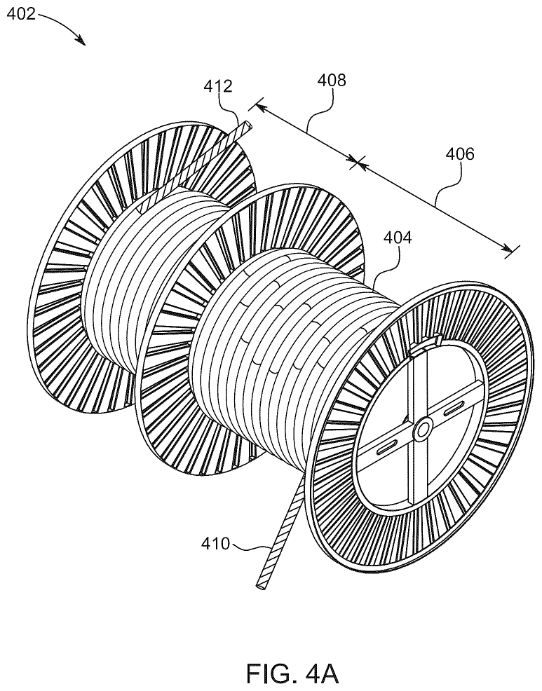

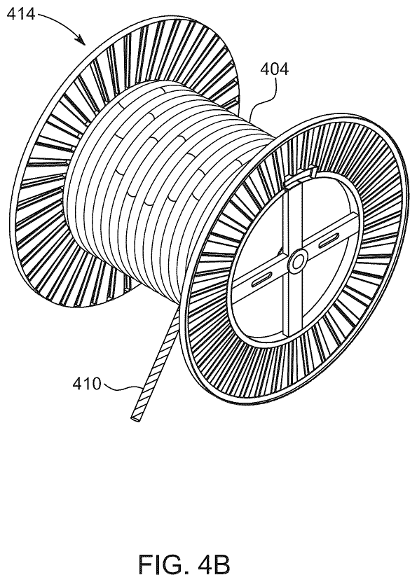

FIG. 4A depicts a first example reel 402 of a factory terminated HCF cable 404 in accordance with one or more embodiments of the present disclosure. The HCF cable 404 may be the same as the cables 102, 202 described above. In this case, the HCF cable 404 may be packaged on the reel 402. In certain embodiments, on one or both ends of the cable, the fibers that are part of the cable are placed in a splice closure or splice tray to further facilitate installation, allowing for quicker joining to another cable during the installation process.

The factory terminated HCF cable 404 may be terminated at one end, the other end of the cable may or may not be terminated. The reel 402 may have a wide traverse 406 and a narrow traverse 408. A factory terminated primary pulling end 410 of the factory terminated HCF cable 404 is wound around the wide traverse section 406 of the reel 402. A non-primary, last end 412 of the factory terminated HCF cable 404 is wound around the narrow traverse section 408 of the reel 402.

During the installation process, the reel 402 may be transported to the installation site, where the factory terminated HCF cable 404 simplifies the splicing at the installation site, as described above.

FIG. 4B depicts a second example reel 414 of the HCF cable 404 in accordance with one or more embodiments of the present disclosure. In this case, the factory terminated primary pulling end 410 of the HCF cable 404 may be accessible on the outer layers of the reel 414. The non-primary, last-end 412 of the HCF cable 404 may be in the inner layers of the reel 414. In certain embodiments, on one or both ends of the cable, the fibers that are part of the cable are placed in a splice closure or splice tray to further facilitate installation, allowing for quicker joining to another cable during the installation process.

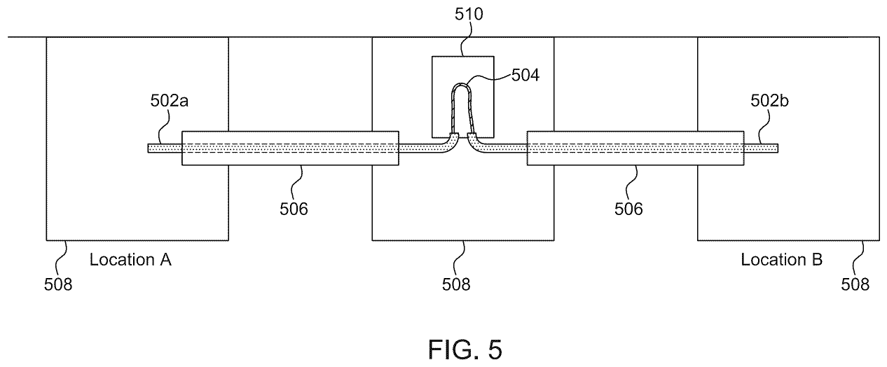

FIG. 5 depicts a connection of two factory terminated HCF cables 502a, 502b in accordance with one or more embodiments of the present disclosure. The HCF cables 502a, 502b may be similar to the HCF cables 102, 202 described above. In this case, a proximal end of an EF of the HCF cable 502a (that may not be spliced/coupled with the HCF of the HCF cable 502a) may be spliced or coupled with a distal end of an EF of the HCF cable 502b (that may not be spliced/coupled with the HCF of the HCF cable 502b) to form an elongated HCF cable, as shown in FIG. 5. For example, if the HCF cables 502a, 502b are individually of 20 Kms each, the EFs of the HCF cables 502a, 502b may be spliced or coupled to form an elongated HCF cable of length 40 Kms.

It would be appreciated from the description above that it is typically easier and faster to splice an EF to another EF, as compared to splicing an HCF to another HCF. Further, EFs can provide relatively robust handling and low bending loss, which may make the splicing process faster, easier, and lower cost compared to HCF splicing and handling. As an illustration, certain HCFs exhibit sensitivity to bending loss, necessitating splicing in large splicing closures or trays. Splicing EF to EF instead of HCF to HCF helps alleviate this issue.

FIG. 5 depicts an embodiment where two factory terminated HCF cables 502a, 502b are spliced together via their respective EFs (shown as EFs 504 in FIG. 5). In this case, the splicing of the two factory terminated HCF cables 502a, 502b may be performed in the EF sections 504 to provide both desired optical transmission properties of the cable as a whole and easy splicing by using traditional techniques suitable for EFs 504 (e.g., suitable for GCF/SCFs, or suitable for conventional SMF/MMF).

FIG. 5 specifically depicts an embodiment to create an optical link connecting a Location A to a Location B via two (or multiple) factory terminated HCF cables 502a, 502b that may be installed inside underground ducts 506 from Locations A to B. The factory terminated HCF cables 502a, 502b may be pulled inside the ducts 506 by using a pulling rope connected to the pulling grip 302 of the factory termination, as described above. The pulling equipment (capstan or winch) may include a tension control device so that the pulling tension does not exceed the maximum tension of the pulling grip 302 of the factory terminated HCF cables 502a, 502b. Once the terminated ends are at the splice location, the pulling grips 302 may be removed to expose the EFs 504. The EFs 504 of respective HCF cables 502a, 502b may then be spliced by using conventional splicing machines and procedures. The splice between the EFs 504 may be performed in a variety of locations such as, but not limited to, manholes 508, handholes, or the like. To protect the splice points, the end fiber splices are protected inside a fiber splice closure 510. Note that individual HCF or the EF of the factory terminated HCF cables 502a, 502b are not shown in FIG. 5 for simplicity and clarity purpose. In certain embodiments, during cable manufacturing, one end of the fibers that are part of the cable are placed in a splice closure or splice tray to further facilitate installation, allowing for quicker joining to another cable during the installation process.

In some aspects, the EFs 504 may contain multiple fibers lengths to achieve low loss splice to the HCF. Further, the EFs 504 may be a glass core fiber optimized to achieve low splicing loss when splicing the two factory terminated HCF cables 502a, 502b.

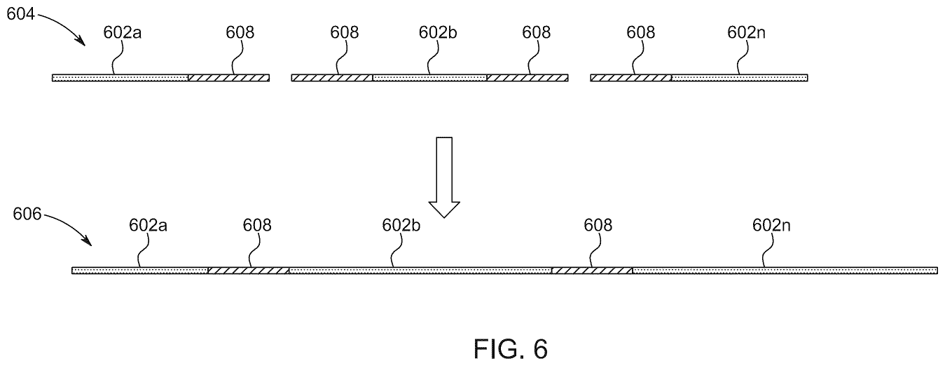

FIG. 6 depicts a connection of multiple factory terminated HCF cables 602a, 602b, 602n in accordance with one or more embodiments of the present disclosure. A view 604 of FIG. 6 depicts the HCF cables 602a, 602b, 602n before splicing, and a view 606 of FIG. 6 depicts the HCF cables 602a, 602b, 602n connected with each other serially by splicing/coupling their respective EFs 608. In particular, the view 606 depicts a configuration in which the EF sections 608 of the factory terminated HCF cables 602a, 602b, 602n are spliced or otherwise coupled together (e.g., using typical GCF splicing or coupling techniques) to form an elongated HCF cable. Note that individual HCFs of the HCF cables 602a, 602b, 602n are not shown in FIG. 6 for clarity.

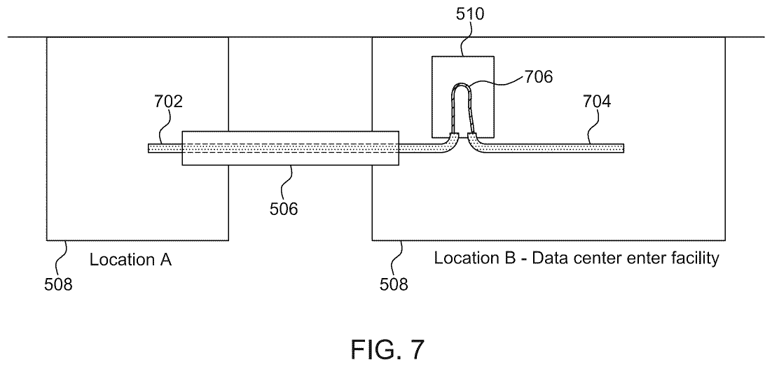

FIG. 7 depicts a connection of a factory terminated HCF cable 702 with a conventional solid/glass core fiber cable 704 (e.g., a conventional SMF/MMF cable) in accordance with one or more embodiments of the present disclosure. In this case, a proximal end of an EF 706 of the HCF cable 702 (i.e., the end of the EF 706 that is not spliced/coupled with the HCF of the HCF cable 702) may be spliced/coupled with the solid/glass core fiber cable 704. The splicing of the EF 706 with the solid/glass core fiber cable 704 may be performed to provide both desired optical transmission properties of the cable as a whole and easy splicing by using traditional techniques suitable for EFs (e.g., suitable for GCFs).

In the exemplary embodiment depicted in FIG. 7, the HCF cable 702 may be installed underground inside a conduit that runs from a Location A (outside a data center building) to a Location B inside a data center building (typically a cable entrance facility). The factory terminated HCF cable 702 may be installed inside the conduit by pulling using a pulling rope until the HCF cable 702 enters into the data center cable entrance facility. To connect the factory terminated HCF cable 702 to equipment inside the data center, the factory terminated HCF cable 702 may be spliced to the conventional SMF cables 704 (or other type of SCF/GCF). The splices may be performed in a variety of devices such as, wall mounted splice cabinet, splice closure 510, or the like. In particular, it is typically easier to splice the EF 706 to a SMF compared to splicing an HCF to an SMF. Further, EFs can provide low splice loss to SMF, relatively robust handling and low bending loss, which may make the splicing process faster, easier, and lower cost compared to HCFs splicing to conventional SMFs.

In this case, the EF 706 may contain multiple fiber lengths to achieve low loss splice to the conventional SCF/GCF or the conventional single-mode fibers. Further, the EF 706 may be or be compatible with conventional SMF (ITU-G.652, G.657, G.654, etc.), so that the EF 706 can be spliced with low loss to conventional single-mode fiber cables.

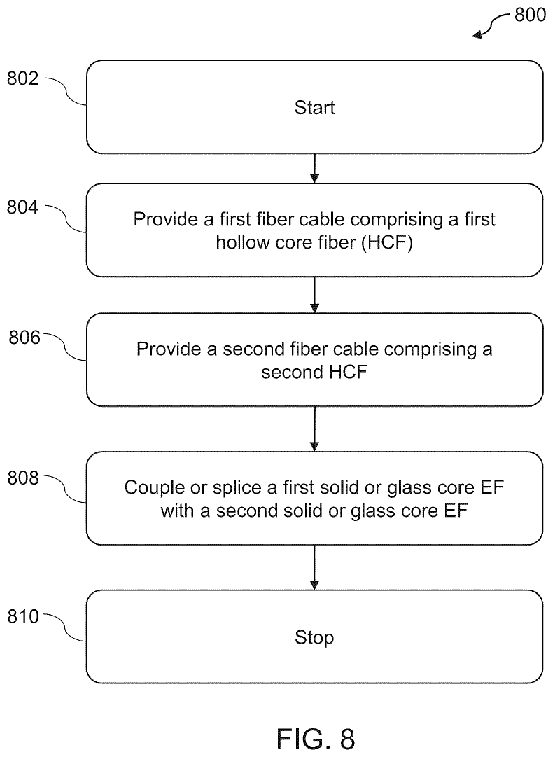

FIG. 8 is a flow diagram of a method 800 to connect two factory terminated HCF cables in accordance with one or more embodiments of the present disclosure. Applicant notes that the embodiments and enabling technologies described previously herein in the context of the factory terminated HCF cables should be interpreted to extend to the method 800. It is further noted, however, that the method 800 is not limited to the architecture/structure/operation of the factory terminated HCF cables described above. The steps described in conjunction with the method 800 may be performed by an operator or a controller/processor.

The method 800 may start at step 802. At step 804, the method 800 may include providing a first fiber cable comprising a first HCF. The first HCF may be factory terminated at a proximal end of the first HCF with a first solid or glass core EF. At step 806, the method 800 may include providing a second fiber cable comprising a second HCF. The second HCF may be factory terminated at a distal end of the second HCF with a second solid or glass core end fiber EF. At step 808, the method 800 may include coupling or splicing the first solid or glass core EF with the second solid or glass core EF.

Within the method 800, in embodiments after step 808, although it could be before step 808, on one or both ends of the cable, the fibers that are part of the cable are placed in a splice closure or splice tray to further facilitate installation, allowing for quicker joining to another cable during the installation process. The method 800 may end at step 810.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments in the present disclosure have been described in some detail for purposes of clarity of understanding, the invention is not limited to the details provided. There are many alternative ways of implementing the invention. The disclosed embodiments are illustrative and not restrictive.

What is claimed is:

1. A fiber cable comprising a hollow core fiber (HCF), wherein the HCF is factory terminated at a proximal end of the HCF with a solid or glass core end fiber (EF) of a first predefined length and wherein the EF is either a single-mode fiber or a multimode fiber.

2. The fiber cable of claim 1, wherein the HCF is further factory terminated with a second solid or glass core EF at a distal end of the HCF.

3. The fiber cable of claim 1 further comprising a pulling grip that encloses the proximal end that is factory terminated with the solid or glass core EF, wherein the pulling grip is configured to protect the proximal end that is factory terminated from ambient environment and facilitate deployment of the fiber cable inside conduits.

4. The fiber cable of claim 3, wherein the pulling grip is water resistant and is configured to handle a pulling tension of more than 500 Newton.

5. The fiber cable of claim 3, wherein a diameter of the pulling grip is greater than a diameter of the fiber cable, and wherein a difference between the diameter of the pulling grip and the diameter of the fiber cable is less than 2 centimeters.

6. The fiber cable of claim 3, wherein a length of the pulling grip is less than 2 meters.

7. The fiber cable of claim 1, wherein the HCF is factory terminated at the proximal end with the solid or glass core EF by coupling the proximal end of the HCF with a distal end of the solid or glass core EF.

8. The fiber cable of claim 7, wherein the distal end of the solid or glass core EF is coupled with the proximal end of the HCF by using a mechanical splice or couplers.

9. The fiber cable of claim 7, wherein the proximal end of the HCF and the distal end of the solid or glass core EF are protected by at least one of a buffer tube, an aramide yarn or a tape, after the proximal end of the HCF is coupled with the distal end of the solid or glass core EF.

10. The fiber cable of claim 7, wherein the distal end of the solid or glass core EF is surface treated or coated with an antireflection coating.

11. The fiber cable of claim 1, wherein a distal end of the solid or glass core EF is spliced or coupled with the proximal end of the HCF, and wherein a proximal end of the solid or glass core EF is terminated with a connector that is one of: a Lucent connector, a Square connector, an LC angled physical connector (LC-APC), or an SC angled physical connector (SC-APC).

12. The fiber cable of claim 11, wherein the associated loss is less than 0.1 dB.

13. The fiber cable of claim 1, wherein a coupling of the proximal end of the HCF and the solid or glass core end fiber (EF) has an associated reflectance loss of less than −65 dB.

14. The fiber cable of claim 1, wherein a coupling of the proximal end of the HCF and the solid or glass core EF is re-coated or protected with a splice protector.

15. The fiber cable of claim 1, wherein the proximal end of the HCF and the solid or glass core EF are protected with one or more of: a protective tube, a heat shrink material, an epoxy material or a mechanical seal.

16. The fiber cable of claim 1, wherein a cladding diameter or a mode field diameter of the HCF is equivalent to a cladding diameter or a mode field diameter of the solid or glass core EF.

17. The fiber cable of claim 1, wherein the first predefined length is greater than five meters.

18. A fiber comprising a hollow core fiber (HCF) having a first length and a proximal end and a distal end, wherein the proximal end is factory terminated with a distal end of a solid or glass core end fiber (EF) that has a second length, wherein the first length is greater than the second length, wherein the proximal end of the HCF is coupled with the distal end of the solid or glass core EF by using a mechanical splice or couplers, and wherein the associated loss is less than 0.1 dB.

19. The fiber of claim 18, wherein a coupling of the proximal end of the HCF and the solid or glass core end fiber (EF) has an associated reflectance loss of less than −65 dB.

20. A method comprising:
providing a first fiber cable comprising a first hollow core fiber (HCF), wherein the first HCF is factory terminated at a proximal end of the first HCF with a first solid or glass core end fiber (EF);
providing a second fiber cable comprising a second HCF, wherein the second HCF is factory terminated at a distal end of the second HCF with a second solid or glass core end fiber EF; and
coupling or splicing the first solid or glass core EF with the second solid or glass core EF.
